(19) United States
(12) Patent Application Publication
(10) Pub. No.: US 2010/0175837 A1
(43) Pub. Date: Jul. 15, 2010

(54) PRIVACY DEVICE AND PRIVACY DISPLAY

(75) Inventors: Lin Yuan You, Taiwan (TW); Chao Teh Ho, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: BENQ CORPORATION, Taipei County (TW)

(21) Appl. No.: 12/686,147

(22) Filed: Jan. 12, 2010

(30) Foreign Application Priority Data
Jan. 13, 2009 (TW) 098101050

(51) Int. Cl. E05F 15/20; E06B 9/24; E06B 9/56

(52) U.S. Cl. 160/7; 160/371; 160/309

(57) ABSTRACT

The invention discloses a privacy device applied in a display. The display includes a screen. The privacy device of the invention includes a privacy film and a driving member. The privacy film is used for covering the screen. The driving member is disposed around the screen and operatively connected to the privacy film for driving the privacy film to move relative to the screen; wherein, the driving member is capable of selectively driving the privacy device to completely cover the screen or completely reveal the screen.

### BACKGROUND OF THE INVENTION

1. Field of the Invention

This invention relates to a privacy device and a privacy display, and more particularly, to the privacy device which is capable of selectively switch the privacy film therein manually or automatically and the privacy display in which the privacy device is installed.

2. Description of the Related Art

Nowadays, since electronic products are getting popularized, people quite rely on the electronic products to handle their works. In order to protect the privacy of information not to be peeped at by other people, a variety of the privacy devices are massively used in the electronic products.

In most of the prior privacy devices, the privacy films are adopted to be adhered on the surface of the screens to achieve the purpose of keeping privacy. When there is somebody around, a user can adhere a privacy film onto the screen to prevent the person from peeping at the information on the screens.

While using the electronic products alone, the user must take off the privacy film for better quality of displaying and performances of optical properties. The method of continually adhering and taking off the privacy film is inconvenient and perplexes users.

### SUMMARY OF THE INVENTION

A scope of the invention is to provide a privacy device.

According to an embodiment, the privacy device is applied in a display. The privacy device includes a screen and a frame, and the frame is disposed along the edge of the screen.

The privacy device of the invention includes a privacy film and a driving member. The privacy film can be used to cover the screen. The driving member can be disposed in the frame and operatively connected to the privacy film for driving the privacy film to move relative to the screen. Wherein, the driving member is capable of selectively driving the privacy film to completely cover the screen or completely reveal the screen.

Another scope of the invention is to provide a privacy display.

According to another embodiment, the privacy display of the invention includes a screen, a frame, a privacy device, and a switch module. Wherein, the frame is disposed along the edge of the screen.

The privacy device can be disposed in the frame of the display and includes a privacy film and a driving member. The privacy film can be used to cover the screen. The driving member is operatively connected to the privacy film for driving the privacy film to move relative to the screen. The switch module can be disposed at the screen for generating a driving signal. Wherein, the driving member is capable of selectively driving the privacy film to completely cover the screen or completely reveal the screen according to the driving signal.

Compared with prior arts, the privacy device and the privacy display according to the invention is comprised of a particular design—a driving member such that the privacy film can be controlled by the driving member to achieve the goal of privacy. The invention adopts the design that the privacy device is disposed in the display instead of the design which needs to continually adhere and take off the privacy film. Thus, the users can actuate the privacy function conveniently. Moreover, since the privacy film is installed in the screen and a camera which can dynamically detect the image in front of the screen can be adopted, the privacy device and the privacy display of the invention can actuate the privacy function automatically when someone's image is appeared, so as to achieve the goal of privacy.

The advantage and spirit of the invention may be understood by the following recitations together with the appended drawings.

### BRIEF DESCRIPTION OF THE APPENDED DRAWINGS

FIG. 1 is a schematic diagram illustrating a display which applies a privacy device of the invention.

FIG. 2 is a cross-sectional view illustrating the display along line 2-2 in FIG. 1.

FIG. 3 is a cross-sectional view similar to FIG. 2 but illustrating that the privacy film completely reveals the screen in FIG. 1.

FIG. 4 is a cross-sectional view similar to FIG. 2 but illustrating that the privacy film completely covers the screen in FIG. 1.

FIG. 5 is a cross-sectional view similar to FIG. 2 but illustrating the privacy device according to an embodiment of the invention.

FIG. 6 is a perspective view illustrating the privacy device in FIG. 5.

FIG. 7 is a cross-sectional view similar to FIG. 2 but illustrating the privacy device according to another embodiment of the invention.

FIG. 8 is a cross-sectional view similar to FIG. 2 but illustrating that the privacy film completely reveals the screen in FIG. 7.

FIG. 9 is a cross-sectional view similar to FIG. 2 but illustrating that the privacy film completely covers the screen in FIG. 7.

FIG. 10 is a perspective view illustrating the privacy device in FIG. 8.

FIG. 11 is a cross-sectional view similar to FIG. 2 but illustrating the privacy device according to another embodiment of the invention.

FIG. 12 is a cross-sectional view similar to FIG. 2 but illustrating that the privacy film completely reveals the screen in FIG. 11.

FIG. 13 is a cross-sectional view similar to FIG. 2 but illustrating that the privacy film completely covers the screen in FIG. 11.

FIG. 14 is a perspective view illustrating the privacy device in FIG. 11.

FIG. 15 is a schematic diagram illustrating the privacy display according to an embodiment of the invention.

### DETAILED DESCRIPTION OF THE INVENTION

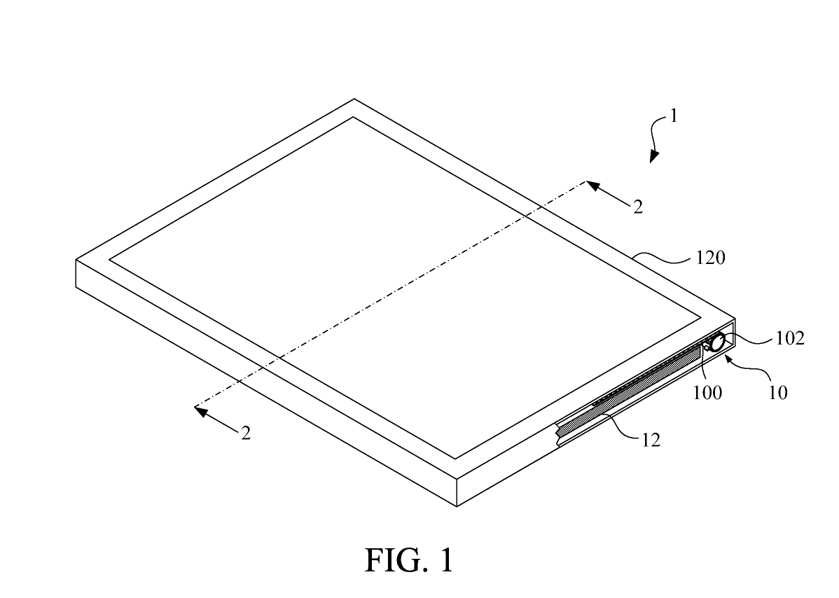

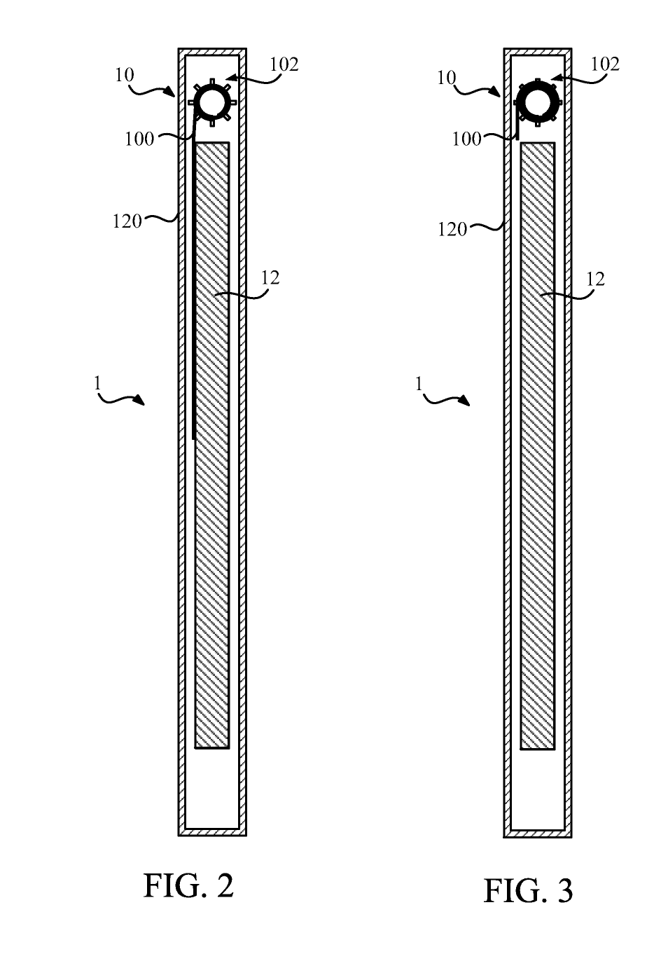

Please refer to FIG. 1 and FIG. 2. FIG. 1 is a schematic diagram illustrating a display 1 which applies a privacy device 10 of the invention. FIG. 2 is a cross-sectional view illustrating the display 1 along line 2-2 in FIG. 1. The privacy device 10 of the invention can be applied to display 1. The display 1 includes a screen 12 and frame 120, and the frame 120 is disposed along the edge of the screen 12. The privacy device 10 of the invention includes a privacy film 100 and a driving member 102; wherein, the privacy film 100 can be used to cover the screen 12 to prevent other person from peeping at the contents on the display 1 when the user is using the display 1.

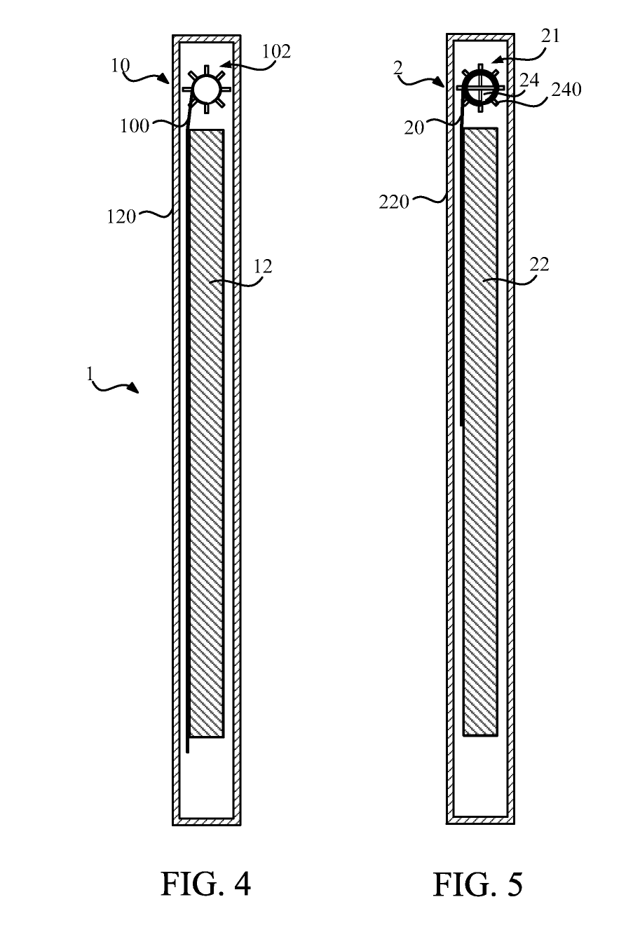

Please refer to FIG. 3 and FIG. 4. FIG. 3 is a cross-sectional view similar to FIG. 2 but illustrating that the privacy film 100 completely reveals the screen 12 in FIG. 1. FIG. 4 is a cross-sectional view similar to FIG. 2 but illustrating that the privacy film 100 completely covers the screen 12 in FIG. 1. The driving member 102 is disposed in the frame 120 of the display 1 and operatively connected to the privacy film 100 for driving the privacy film 100 to move relative to the screen 12. The driving member 102 is capable of selectively driving the privacy film 100 to completely cover the screen 12 (as shown in FIG. 4) or completely reveal the screen 12 (as shown in FIG. 3). When the privacy film 100 completely covers the screen 12, the display 1 can truly prevent other person around the user from peeping at the contents on the display 1. When the privacy film 100 completely reveals the screen 12, the user can normally see the contents on the display 1 without deteriorating the display quality.

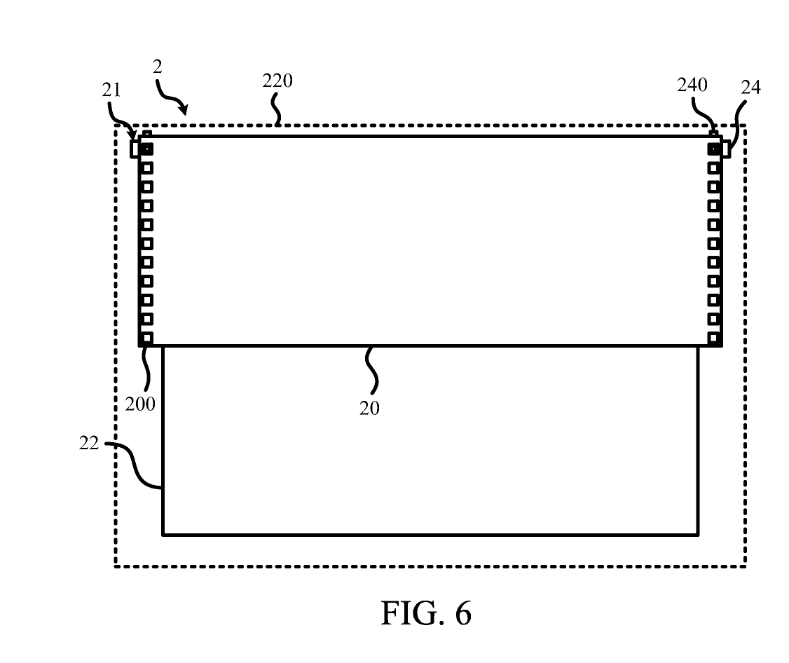

Please refer to FIG. 5, FIG. 6, FIG. 3 and FIG. 4. FIG. 5 is a cross-sectional view similar to FIG. 2 but illustrating the privacy device 2 according to an embodiment of the invention. FIG. 6 is a perspective view illustrating the privacy device 2 in FIG. 5. The privacy device 2 of the invention includes a privacy film 20 and a driving member 21. The driving member 21 includes a shaft 24 which is rotatably disposed in the frame 220 at the periphery of the screen 22. In practical application, the driving member 21 can be disposed in the frame 220 above, under, or at two sides of the screen 22. The shaft 24 has at least one block 240 which further connects to an end of the privacy film 20; wherein, the privacy film 20 has chain holes 200. The chain holes 200 are engaged with the at least one block 240 of the shaft 24.

In the embodiment, when the shaft 24 rotates, the privacy film 20 will be actuated by the at least one block 240 which engages with the chain holes 200 to selectively cover or reveal the screen 22; wherein, when the screen 22 is completely revealed, the privacy film 20 is rolled and bundled by the shaft, as shown in FIG. 3.

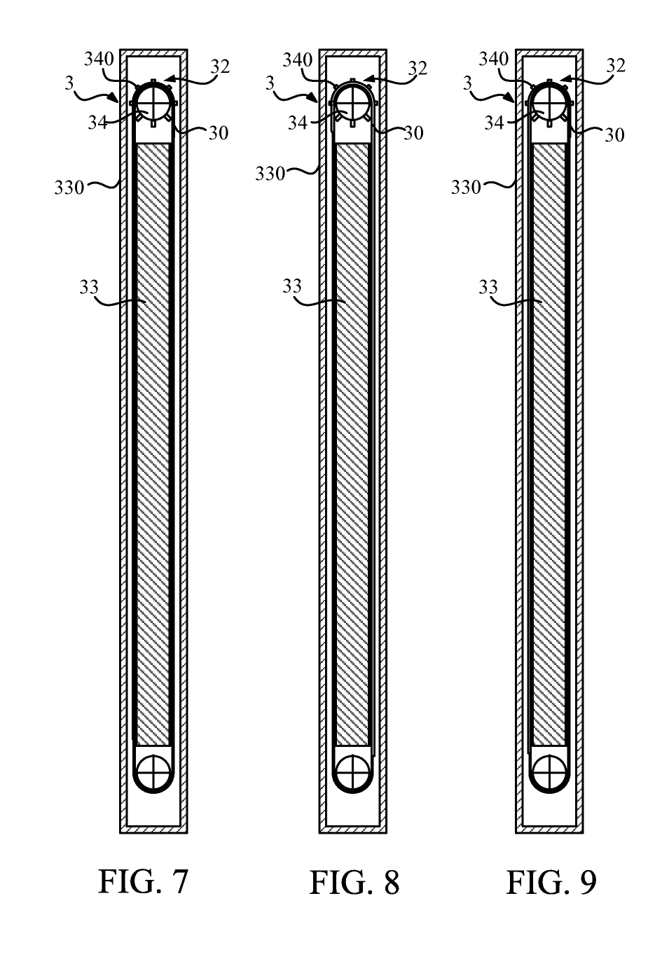

Please refer to FIG. 7. FIG. 7 is a cross-sectional view similar to FIG. 2 but illustrating the privacy device 3 according to another embodiment of the invention. The privacy device 3 of the invention includes a privacy film 30 and a driving member 32. The driving member 32 includes a shaft 34 which is rotatably disposed in the frame 330 at the periphery of the screen 33. In practical application, the driving member 32 can be disposed in the frame 330 above, under, or at two sides of the screen 33; wherein, the shaft 34 has at least one block 340.

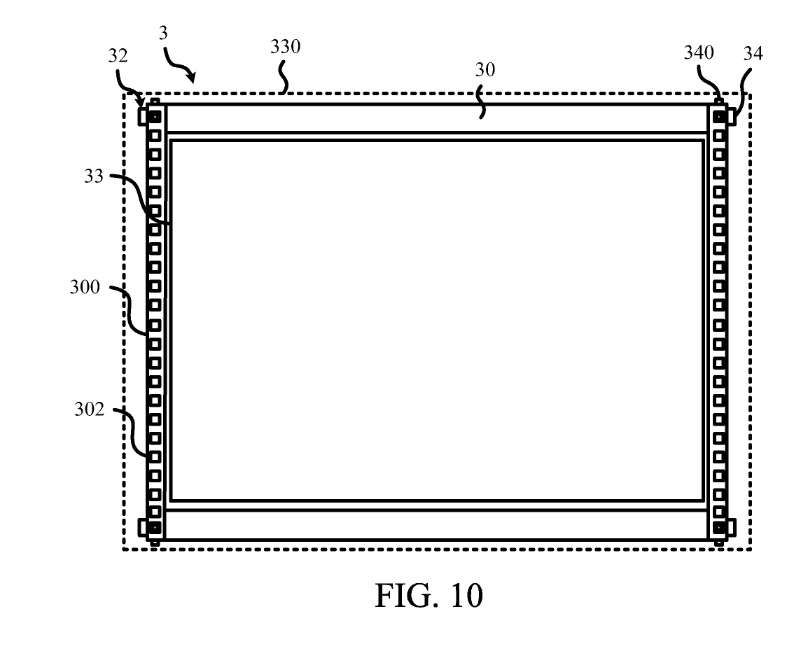

Please refer to FIG. 8, FIG. 9, and FIG.10. FIG. 8 is a cross-sectional view similar to FIG. 2 but illustrating that the privacy film 30 completely reveals the screen 33 in FIG. 7. FIG. 9 is a cross-sectional view similar to FIG. 2 but illustrating that the privacy film 30 completely covers the screen 33 in FIG. 7. FIG. 10 is a perspective view illustrating the privacy device 3 in FIG. 8. Please refer to FIG. 10, in the embodiment, the privacy film 30 have an engagement portion 300 for the at least one block 340 of driving member 32 on the shaft 34 to engage; wherein, the engagement portion 300 of the privacy film 30 is connected from beginning to end and encircles the screen 33 and the shaft 34. Moreover, the engagement portion 300 of the privacy film 30 further includes a plurality of chain holes 302 for the at least one block 340 of the shaft 34 to engage. When the shaft 34 rotates, the privacy film 30 will be actuated by the at least one block 340 which engages with the engagement portion 300 of the privacy film 30 to selectively drive the privacy film 30 to cover the screen 33 (as shown in FIG. 9) or reveal the screen 33 (as shown in FIG. 8). Thereby, when the screen 33 is completely revealed, the privacy film 30 is completely moved to the reverse side of the screen 33 by the shaft 34, as shown in FIG. 10.

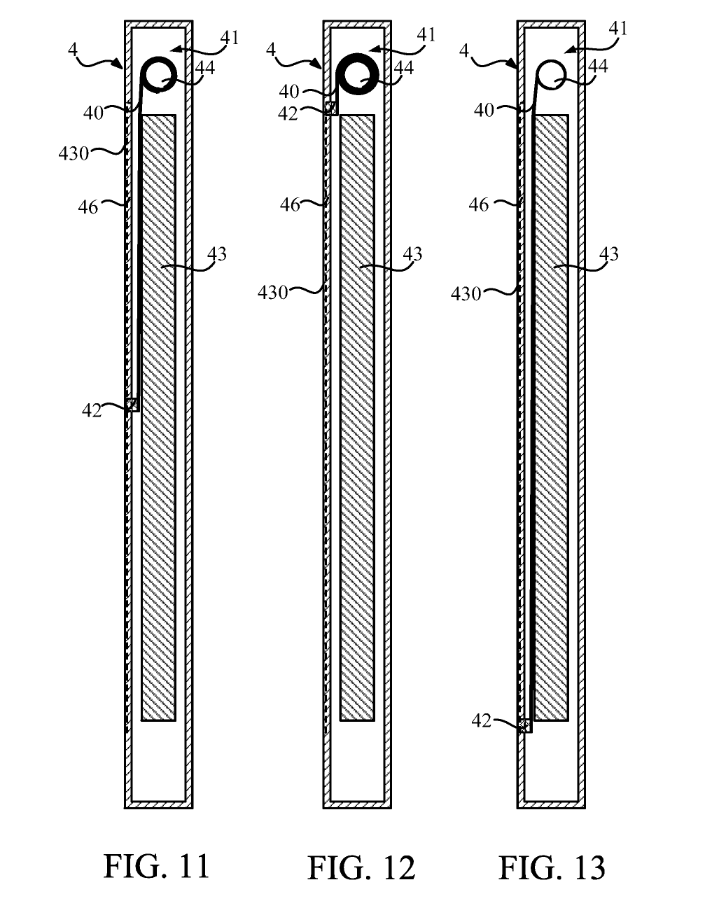

Please refer to FIG. 11. FIG. 11 is a cross-sectional view similar to FIG. 2 but illustrating the privacy device 4 according to another embodiment of the invention. The privacy device 4 of the invention includes a privacy film 40 and a driving member 41. The privacy device 4 of the invention have a slide rail 46 which is disposed along the frame 430 at the periphery of the screen 43, and the driving member 41 includes a sliding member 42 and a shaft 44; wherein, the sliding member 42 connects to an end of the privacy film 40 to selectively actuate the privacy film 40.

In the embodiment, the shaft 44 can be rotatably disposed in the frame 430 at the periphery of the screen 43. In practical application, the driving member 41 can be disposed in the frame 430 above, under, or at two sides of the screen 43. Moreover, the shaft 44 connects to another end of the privacy film 40. Furthermore, the shaft 44 can has a torsional force which can roll and bundle the privacy film 40 in advance.

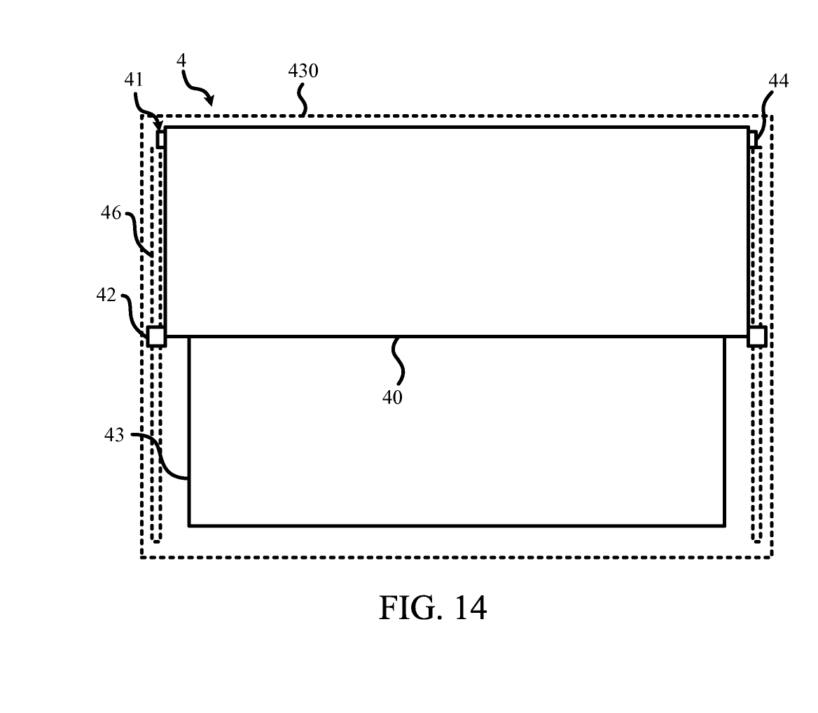

Please refer to FIG. 12, FIG. 13 and FIG. 14. FIG. 12 is a cross-sectional view similar to FIG. 2 but illustrating that the privacy film 40 completely reveals the screen 43 in FIG. 11. FIG. 13 is a cross-sectional view similar to FIG. 2 but illustrating that the privacy film 40 completely covers the screen 43 in FIG. 11. FIG. 14 is a perspective view illustrating the privacy device 4 in FIG. 11. When the sliding member 42 slides relative to the slide rail 46, the privacy film 40 will be actuated by the sliding member 42 to selectively cover the screen 43 (as shown in FIG. 13) or reveal the screen 43 (as shown in FIG. 12). Please refer to FIG. 14; the sliding member 42 of the driving member 41 takes a block as an example, and the slide rail 46 disposed along the frame 430 at the periphery of the screen 43 takes a groove which adapted to the block as an example, but they are not limited to above-mentioned examples only. In practical application, the slide rail 46 can be a block which is disposed along the frame 430 at the periphery of the screen 43, and the groove adapted to the block can be disposed on the sliding member 42. Or, the sliding member 42 can be a roller, and the roller is guided by the sliding rail 46 to roll during the operation. Additionally, in an embodiment, when a user wants to drive the privacy film 40 to cover the screen 43, the sliding member 42 can generate a driving force which is larger than the torsional force of the shaft 44, such that the privacy film 40 can be driven to completely cover the screen 43. When the user wants to reveal the screen 43, the sliding member 42 can generate no driving force and then let the torsional force of the shaft 44 actuate the privacy film 40 to be rolled and bundled, such that the screen 43 can be completely revealed. In another embodiment, the sliding member 42 can be driven by the shaft 44. When the user wants to drive the privacy film 40 to cover the screen 43, the shaft 44 provides a downward force to the sliding member 42; when the user wants to reveal the screen 43, the shaft 44 provides an upward force to the sliding member 42. Thus, the privacy film 49 can be driven to completely cover the screen 43 or rolled and bundled to completely reveal the screen 43.

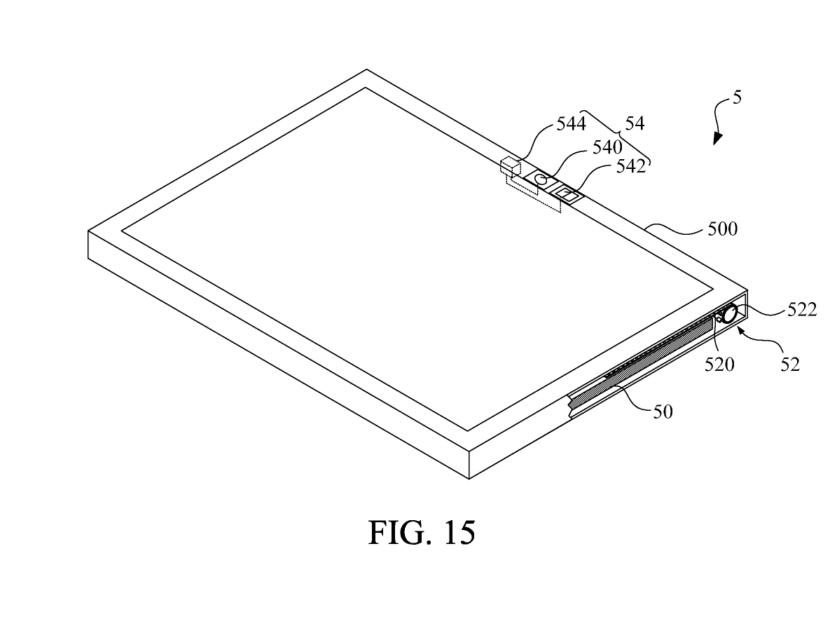

Please refer to FIG. 15. FIG. 15 is a schematic diagram illustrating the privacy display 5 according to an embodiment of the invention. The invention further provides a privacy display 5 which includes a screen 50, a privacy device 52, and a switch module 54.

In the embodiment, the privacy device 52 can be disposed in the frame 500 at the periphery of the screen 50 and includes a privacy film 520 and a driving member 522; wherein, the privacy film 520 can be used to cover the screen 50, such that others around the user can be prevented from peeping at the contents on the privacy display 5 when the user is using the privacy display 5.

Additionally, the driving member 522 is operatively connected to the privacy film 520 for driving the privacy film 522 to move relative to the screen 50. The switch module 54 can be disposed at the frame 500 at the periphery of the screen and includes an image capture unit 540, an image analysis unit 544 and a switch 542.

Wherein, the image capture unit 540 can be used to capture an image in front of the screen 50. The image analysis unit 544 is electrically connected to the image capture unit 540 for recognizing a predetermined user in the image. The image capture unit 540 can be a dynamic camera or a camera which is installed inside the display 50.

When the image analysis unit 544 recognizes that a moving body is different from the predetermined user in the image, such as another person, the image analysis unit 544 will generate a driving signal, such that the driving member 522 can selectively drive member 520 to completely cover the screen 50 or completely reveal the screen 50 according to the driving signal. When the privacy film 520 completely covers the screen 50, the privacy display 5 can truly prevent another person which around the user from peeping at the contents on the screen 50. When the privacy film 520 completely reveals the screen 50, the screen 50 can completely display the contents with quality.

Additionally, the switch 542 of the switch module 54 can be used to provide another approach to the user to selectively start or stop the image analysis unit 544 generating the driving signal. Thus, the driving member 522 can be selectively driven to actuate the privacy film 520 to completely cover the screen 50 or completely reveal the screen 50 according to the driving signal.

To sum up, according to a preferred embodiment of the invention, the privacy function of the privacy display 5 of the invention can be actuated manually or automatically.

Compared with prior arts, the privacy device and the privacy display according to the invention is comprised of a particular design—a driving member such that the privacy film can be controlled by the driving member to achieve the goal of privacy. The invention adopts the design that the privacy device is disposed in the display instead of the design which needs to continually adhere and take off the privacy film. Thus, the uses can actuate the privacy function conveniently. Moreover, since the privacy film is installed in the screen and a camera which can dynamically detect the image in front of the screen can be adopted, the privacy device and the privacy display of the invention can actuate the privacy function automatically when someone' image is appeared, so as to achieve the goal of privacy.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. A privacy device, applied in a display, the display comprising a screen and a frame, the privacy device comprising:
a privacy film for covering the screen; and
a driving member, disposed in the frame and operatively connected to the privacy film, for driving the privacy film to move relative to the screen;
wherein the driving member is capable of selectively driving the privacy film to completely cover the screen or completely reveal the screen.

2. The privacy device of claim 1, wherein the driving member comprises a shaft, rotatably disposed at the periphery of the screen and connected to an end of the privacy film, when the shaft rotates, the privacy film is actuated by the rotated shaft to selectively cover the screen or reveal the screen.

3. The privacy device of claim 2, wherein the shaft comprises at least one block, the privacy film has chain holes for the at least one block to engage, when the shaft rotates, the privacy film is actuated by the at least one block which engages with the chain holes to selectively cover the screen or reveal the screen.

4. The privacy device of claim 2, when the screen is completely revealed, the privacy film is rolled and bundled by the shaft.

5. The privacy device of claim 1, wherein the driving member comprises a shaft, rotatably disposed at the periphery of the screen, the shaft have at least one block, the privacy film have an engagement portion for the block to engage, when the shaft rotates, the privacy film is actuated by the at least one block which engages with the engagement portion to selectively cover the screen or reveal the screen.

6. The privacy device of claim 5, when the screen is completely revealed, the privacy film is moved to the reverse side of the screen by the shaft.

7. The privacy device of claim 5, wherein the engagement portion is connected from beginning to end and encircles the screen and the shaft.

8. The privacy device of claim 5, wherein the engagement portion comprises a plurality of chain holes for the at least one block to engage.

9. The privacy device of claim 1, wherein a slide rail is disposed along the periphery of the screen, the driving member comprises a sliding member, the sliding member connects to an end of the privacy film, when the sliding member slides relative to the slide rail, the privacy film is actuated by the sliding member to selectively cover the screen or reveal the screen.

10. The privacy device of claim 9, wherein the driving member comprises a shaft, rotatably disposed at the periphery of the screen and connected to another end of the privacy film, the shaft has a torsional force to roll and bundle the privacy film.

11. A privacy display, comprising:
a screen;
a frame;
a privacy device, disposed in the frame, the privacy device comprising:
a privacy film for covering the screen; and
a driving member, the driving member operatively connecting to the privacy film, for driving the privacy film to move relative to the screen; and
a switch module, disposed around the screen, for generating a driving signal;
wherein the driving member is capable of selectively driving the privacy film to completely cover the screen or completely reveal the screen according to the driving signal.

12. The privacy display of claim 11, wherein the switch module comprises:
an image capture unit for capturing an image around the periphery of the screen; and
an image analysis unit, electronically connected to the image capture unit, for generating the driving signal according to the image.

13. The privacy display of claim 12, wherein the image analysis unit is used to recognize a user in the image, when the image analysis unit recognizes a moving body different from the user in the image, the image analysis unit generates the driving signal.

14. The privacy display of claim 11, wherein the switch module comprises a switch, the switch is used to be selectively opened or closed by user, so as to generate the driving signal.

15. The privacy display of claim 11, wherein the driving member comprises a shaft, rotatably disposed at the periphery of the screen and connected to an end of the privacy film, when the shaft rotates, the privacy film is actuated by the rotated shaft to selectively cover the screen or reveal the screen.

16. The privacy display of claim 15, wherein the shaft comprises at least one block, the privacy film has chain holes for the at least one block to engage, when the shaft rotates, the privacy film is actuated by the at least one block which engages with the chain holes to selectively cover the screen or reveal the screen.

17. The privacy display of claim 15, when the screen is completely revealed, the privacy film is rolled and bundled by the shaft.

18. The privacy display of claim 11, wherein the driving member comprises a shaft, rotatably disposed at the periphery of the screen, the shaft have at least one block, the privacy film have an engagement portion for the block to engage, when the shaft rotates, the privacy film is actuated by the at least one block which engages with the engagement portion to selectively cover the screen or reveal the screen.

19. The privacy display of claim 18, when the screen is completely revealed, the privacy film is moved to the reverse side of the screen by the shaft.

20. The privacy display of claim 18, wherein the engagement portion is connected from beginning to end and encircles the screen and the shaft.

21. The privacy display of claim 18, wherein the engagement portion comprises a plurality of chain holes for the at least one block to engage.

22. The privacy display of claim 11, wherein a slide rail is disposed along the periphery of the screen, the driving member comprises a sliding member, the sliding member connects to an end of the privacy film, when the sliding member slides relative to the slide rail, the privacy film is actuated by the sliding member to selectively cover the screen or reveal the screen.

23. The privacy display of claim 22, wherein the driving member comprises a shaft, rotatably disposed at the periphery of the screen and connected to another end of the privacy film, the shaft has a torsional force to roll and bundle the privacy film.
